(19) United States
(12) Patent Application Publication
(10) Pub. No.: US 2017/0317898 A1
(43) Pub. Date: Nov. 2, 2017

(54) Collaborative Network-Based Graphical Progress Management Platform for Providing Data Monitoring and Data Analysis of Third Party Services

(71) Applicant: Progressly, Inc., Redwood City, CA (US)

(72) Inventors: Nick Candito, Redwood City, CA (US); Clarence Wooten, Palo Alto, CA (US); Eren Emre Kanal, San Francisco, CA (US)

(73) Assignee: Progressly, Inc., Redwood City, CA (US)

(21) Appl. No.: 15/143,110

(22) Filed: Apr. 29, 2016

(51) Int. Cl. H04L 12/26; H04L 29/08; H04L 29/06

(52) U.S. Cl. CPC H04L 43/045; H04L 63/08; H04L 67/02

(57) ABSTRACT

In one embodiment, a progress management system (e.g., collaborative network-based graphical progress management platform) provides data monitoring and data analysis of third party services. In one example, a computer implemented method includes obtaining identification information to identify a user of an organization with respect to the progress management system, obtaining authentication information from at least one third party service of the user, accessing resources of the user for the at least one third party service, attaching or linking these resources to one or more relevant modules within an interface of the progress management system for the user, and initiating a data monitoring sequence for the at least one third party service of the user.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

At least one embodiment of the present invention pertains to a network-based, collaborative, graphical progress management tool having features for providing data monitoring and data analysis of third party services.

### BACKGROUND

In today's busy work environment, a person can become overwhelmed by having to attend numerous meetings, keep track of many projects at the same time, and utilizing numerous software tools and accounts for collaborative work projects. As demands upon a person's time increase, personal efficiency tends to decrease. A user may have access to numerous software tools but not be able to effectively use the features of the tools in an efficient manner.

### SUMMARY

In one embodiment, a progress management system (e.g., collaborative network-based graphical progress management platform) provides data monitoring and data analysis of third party services. In one example, a computer implemented method includes obtaining identification information to identify a user of an organization with respect to the progress management system, obtaining authentication information from at least one third party service of the user, accessing resources of the user for the at least one third party service, attaching or linking these resources to one or more relevant modules within an interface of the progress management system for the user, and initiating a data monitoring sequence for the at least one third party service of the user.

In one example, the method further includes receiving, with the progress management system, notifications from the at least one third party service when a monitored resource is changed, processing notifications received by the progress management system, attaching data obtained from the notifications to an appropriate module within an interface of the progress management system for the user, and updating user records within a database of the progress management system. The method further includes analyzing, with the progress management system, data from at least one resource of at least one third party service. Analyzing the data includes determining an external ID of the at least one resource being modified, determining a date and time when a modification to the at least one resource occurs, determining an external ID of a user who performed the modification, and applying a description of the modification to the resource. The method further includes presenting this analyzed data in real time to a device of the user via a formatted integration user interface across all authorized resources of the user which have been monitored and analyzed.

In one embodiment, a progress management system (e.g., collaborative network-based graphical progress management platform) is integrated with a collaborative software tool. For example, a computer implemented method for implementing this integration includes providing, with the collaborative network-based graphical progress management platform, randomized identification information for secured access to an account of an organization for a collaborative software tool, providing an owner of the account of the organization, which is associated with a group of users using a plurality of processing devices on a network, an ability to add a web component to a hosted web page having a graphical user interface for the collaborative software tool with the web component to provide features of the collaborative network-based graphical progress management platform. The method further includes receiving, with the hosted web page, user input from a user of the account of the organization with the user input including authentication information for authenticating the user with the collaborative software tool, redirecting the user to an authentication process of the collaborative network-based graphical progress management platform in response to receiving the user input from the user, receiving, with the collaborative network-based graphical progress management platform a token and contact information of the user based on the authentication process, and creating a new user credential if the user does not have an account with the graphical progress management platform or locating an existing user credential of the graphical progress management platform based on the authentication process.

The method further includes generating and transmitting encrypted information to a web browser of the user in order to execute authenticated requests and providing an update of the graphical user interface that includes a dashboard corresponding to the account of the organization for the collaborative software tool with selectable options of the collaborative network-based graphical progress management platform including business process options and business templates.

In another embodiment, a computer implemented method for monitoring resources of a user of a plurality of third party services includes obtaining identification information, with a progress management system, to identify a user of an organization with respect to the progress management system, obtaining authentication information, with the progress management system, from at least one third party service of the user, accessing resources of the user for the at least third party service, attaching or linking these resources to one or more relevant modules within an interface of the progress management system for the user, and initiating a data monitoring sequence for the at least third party service of the user.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a block diagram of exemplary system architecture for providing a progress management system in accordance with one embodiment.

FIG. 2 is a block diagram of a system 250 in which a device 230 having a progress management application 252 is in communication with a progress management server 260 in accordance with one embodiment.

FIGS. 3A and 3B illustrate flow diagrams of operations for a progress management system for providing integration of progress management functionality with third party services (e.g., collaborative software tools, social media, etc.) in accordance with one embodiment.

FIG. 4 illustrates a block diagram showing how a progress management system interacts with a collaborative software tool in accordance with one embodiment.

FIG. 5A illustrates a user interface 500 in accordance with one embodiment.

FIG. 5B illustrates a user interface of the collaborative software tool in accordance with one embodiment.

FIG. 6 illustrates a graphical user interface 600 that includes a dashboard of the user for the collaborative software tool with customized options of the collaborative network-based graphical progress management platform including business process options 622 and business templates 624.

FIG. 7 illustrates a flow diagram of operations for a progress management system for providing data monitoring and data analysis of third party services (e.g., SaaS tools, collaborative software tools, social media, etc.) in accordance with one embodiment.

FIG. 8 illustrates a block diagram of a progress management system for providing data monitoring and data analysis of third party services (e.g., SaaS tools, collaborative software tools, social media, etc.) in accordance with one embodiment.

FIG. 9 illustrates an example of a user interface presented by the progress management system when a monitored resource of a third party service is changed in accordance with one embodiment.

FIG. 10 illustrates another example of a user interface presented by the progress management system when a monitored resource of a third party service is changed in accordance with one embodiment.

FIG. 11 shows an example, at a high level, of the internal architecture of a processing system 1600 representing any of the devices mentioned above, e.g., the PM server or any of the client devices in one embodiment.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, such references are not necessarily mutually exclusive either.

Introduced herein is a progress management tool that combines project management, process management and client communication into (in some embodiments) a cloud-based software application, that makes it easy for professionals to turn any project or process into a visual workflow, called a “process,” that communicates progress and keeps team members and stakeholders informed, aligned and on-task. A process is a visual process flow (i.e. a visual representation of a multi-step process) that provides an indication of progress made in performance of the process. Processes make progress visual and transparent, freeing up professionals from having to explain progress on various projects, so that they can spend more time making progress. The technique and apparatus introduced here are collectively called “the tool” to facilitate description. The tool accomplishes this by enabling users to graphically and collaboratively create, edit, share and comment on processes.

Processes are built by using a unique graphical user interface (GUI), provided by the tool, that communicates progress and process via a visual collaborative timeline. A process visually represents progress made in that process, in a single visual representation. It includes a “timeline-based” to-do list (e.g., step boxes) with built in “how-to” instructions and other resources. When “how-to” instructions are included within the steps of a process, the process doubles as a step-by-step process roadmap that can be cloned and even published for purchase by users seeking to execute an existing best-practice workflow.

When progress is made, the collaborator updates a step box of a process to show progress by inserting assets (e.g., by dragging and dropping) such as images, documents, videos or web links from sources such as the collaborator's desktop, mobile device, uniform resource locator (URL), cloud storage providers or other web services. The resulting progress transforms the step box into a visual representation that displays and archives what progress was made, when it was made, who made it, and where the assets are. A process can also be embedded in other Web based content, such as blog posts, web pages and other applications that support HTML.

In one embodiment, the progress management system (e.g., collaborative network-based graphical progress management platform) is integrated with a collaborative software tool. For example, a computer implemented method for implementing this integration includes providing, with the collaborative network-based graphical progress management platform, randomized identification information for secure access to an account of an organization for a collaborative software tool. This provides an owner of the account of the organization an ability to add a web component to a hosted web page having a graphical user interface for the collaborative software tool with the web component to provide features of the collaborative network-based graphical progress management platform. The method further includes generating and transmitting encrypted information to a web browser of the user in order to execute authenticated requests and providing an update of the graphical user interface that includes a dashboard corresponding to the account of the organization for the collaborative software tool with selectable options of the collaborative network-based graphical progress management platform including business process options and business templates.

The tool can be implemented by using a conventional client-server model, which can support desktop clients as well as mobile clients. The server side may be implemented by, for example, one or more server-class computers and data storage devices. The client devices may include, for example, desktop computers, laptop or notebook computers, tablet devices, smartphones, and other types of devices.

Conventional hardware can be used on both the server side and the client side to support software that provides the functionality introduced herein. For example, in one embodiment, the client only needs conventional hardware and a conventional software-implemented web browser to access the tool functionality, which is mostly implemented by software and data on the server side.

The progress management tool can be used in combination with or include a relationship management that involves the capture, analysis, and reporting of communications between a single user, or multiple users, within an organization, and various contacts outside of the organization. When a user engages in communication, in concert with a group of users, from an organization, those users are said to be collaborators. Furthermore, when the user and/or collaborators engage in communication with contacts outside the organization for a specific purpose (e.g., sales, business, recruiting, funding, etc.), a relationship is formed. These communications, between relationships and collaborators, may be part of a series of sequential communication and action stages of a process, such as stages of a sales process (e.g., first contact, product demo, price quote, offer, close), a business development process (e.g., growth identification, partner identification, project assignment, growth tracking), a recruiting process (e.g., candidate contact, resume obtained, initial interview, follow-up interview, offer or decline), as well as other processes which are, or can, be carried out with electronic communications. These communications, once identified as belonging to one or more processes, may then be viewed by users and collaborators involved in the particular process. Furthermore, reports may be generated which summarize, provide different visualizations, show progression within a process, and provide feedback on the progression within a process.

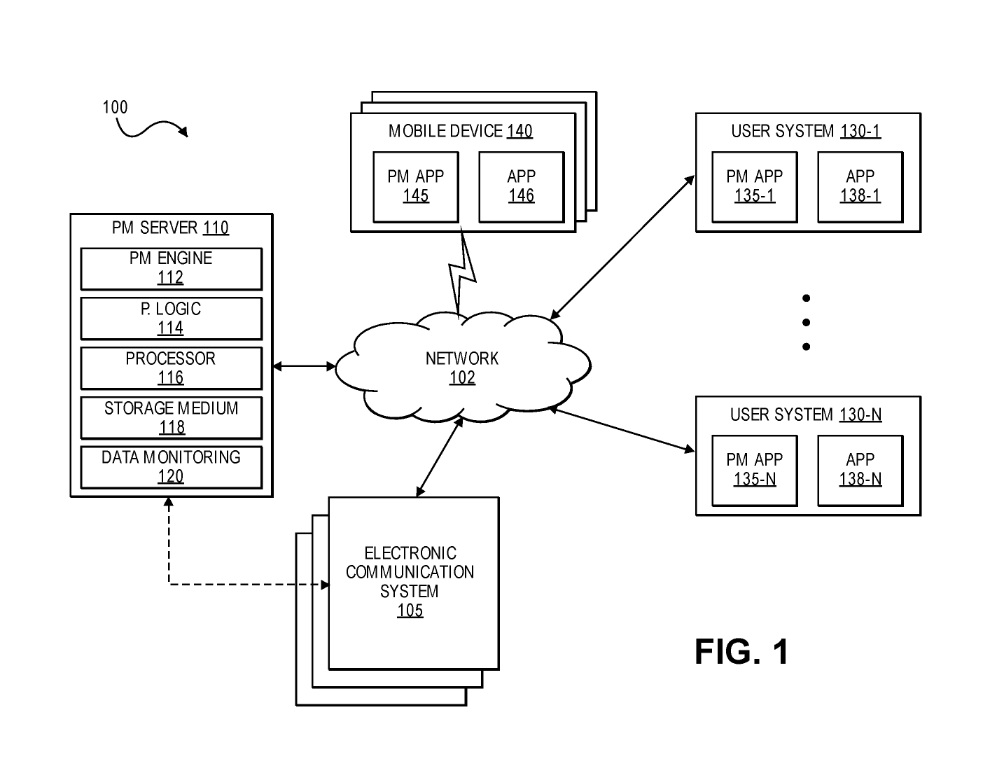

FIG. 1 is a block diagram of exemplary system architecture for providing a progress management system in accordance with one embodiment. In one embodiment, the system 100 includes a plurality of user systems, such as user system 130-1 to user system 130-N, mobile devices 140, progress management server 110, and a plurality of electronic communication systems 105. In one embodiment, user systems 130-1 to user system 130-N may each be a personal computing device, such as a desktop computer, laptop computer, tablet computer, etc. In one embodiment, each mobile device 140 may be a mobile computing device, such as a mobile telephone, personal digital assistant, tablet, etc. The progress management server 110 and electronic communication system 105 may also be computing devices, such as server computers, desktop computers, etc.

The user systems 130-1 through 130-N, mobile devices 140, progress management server 110, and electronic communication system 105 may be coupled to a network 102 and communicate with one another using any of the standard protocols for the exchange of information. In one embodiment, mobile device 140 is coupled with network 102 via a wireless connection, such as a cellular telephone connection, wireless fidelity connection, etc.

In one embodiment, one or more of the user systems 130-1 through user system 130-N, mobile device 140, progress management server 110, and the plurality of electronic communication systems 105 may run on one Local Area Network (LAN) and may be incorporated into the same physical or logical system, or different physical or logical systems. Alternatively, the user systems 130-1 through user system 130-N, mobile device 140, progress management server 110, and the plurality of electronic communication systems 105 may reside on different LANs, wide area networks, cellular telephone networks, etc. that may be coupled together via the Internet but separated by firewalls, routers, and/or other network devices. In yet another configuration, the progress management server 110 and one or more of the electronic communication systems 105 may reside on the same server, or different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, the applications (e.g., 138-1 to 138-N, progress management applications 135-1 through progress management applications 135-N) may be applications presented to a user via a web interface, stand-alone applications installed on user systems 130-1 through 130-N, or a combination of application types. Furthermore, applications (e.g., PM application 145, 146) may be a mobile application. In one embodiment, any of these applications are user applications that enable a user to register with progress management server 110 for the automatic and intelligent creation of a progress management system even if these applications do not relate to progress management. For example, a collaborative software application 146 or 138 may be used for registering with the progress management server 110.

In one embodiment, a progress management application or other type of application, associated with a single user, transmits a registration request and registration data to progress management server 110. The registration data may include a username and password that enables the user to access the progress management server 110. In one embodiment, the registration data may further include usernames and authentication credentials that enable the user to access one or more electronic communication systems 105.

Progress management server 110 receives the registration data and creates a progress management account for the user, and associates the received usernames and authentication credentials with the newly provisioned progress management account. In one embodiment, progress management server 110 automatically obtains past electronic communications to and from the user by utilizing the received usernames and access credentials to access the specified electronic communication systems 105. For example, progress management server 110 may access collaborative software tools, email systems, social networking systems, VOIP systems, teleconferencing systems, etc. Once authenticated into an electronic communication system 105, progress management server 110 accesses the user's past electronic communications.

The PM server 110 includes a PM engine for PM decisions, processing logic 114 (e.g., at least one processor 114), a flow architecture 116 for creating private and public template flows, a storage medium for storing instructions and software programs, and a data monitoring module 120 for monitoring resources for users of third party services.

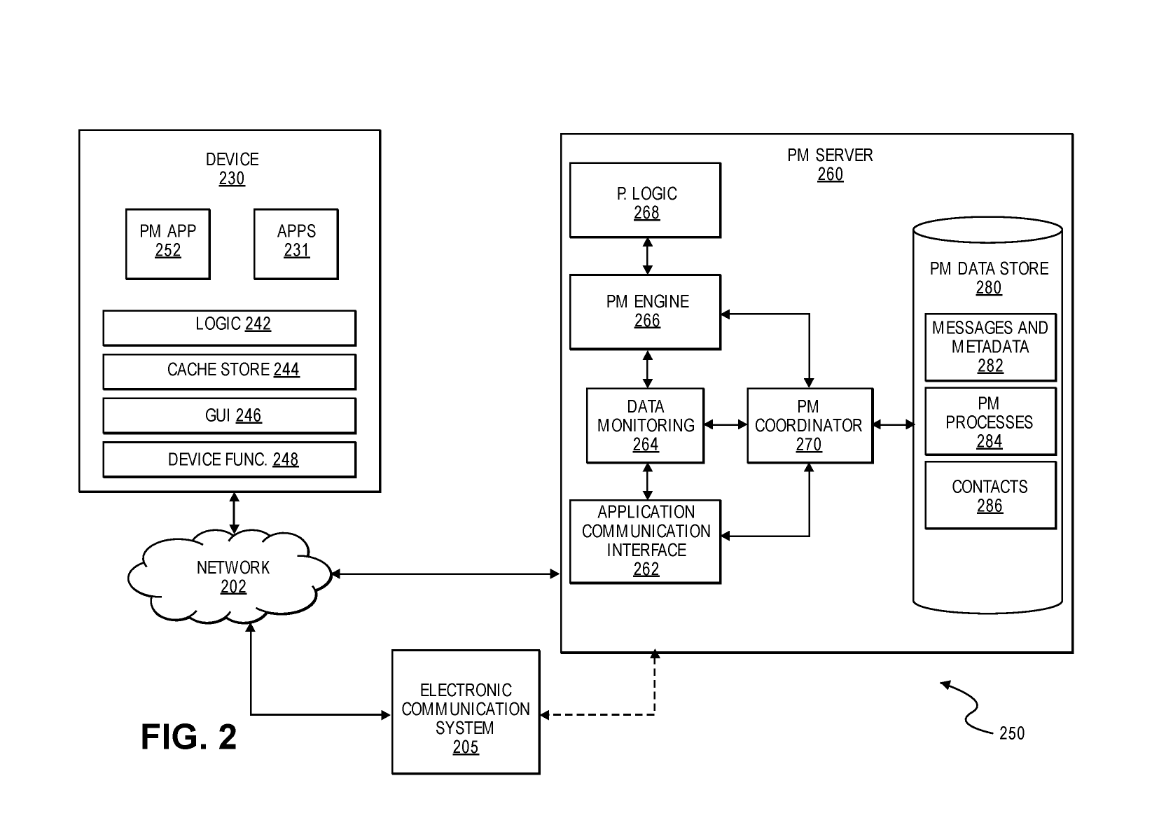

FIG. 2 is a block diagram of a system 250 in which a device 230 is in communication with a progress management server 260 in accordance with one embodiment. Progress management application 252 and a progress management server 260 provide additional details for the progress management applications and a progress management server discussed above in FIG. 1.

In one embodiment, the device 230 includes progress management application 252 and other applications 231. The device 230 (e.g., processing device, source device, client device, mobile device, tablet device, lap top, computer, etc) initiates a software application. For example, a user may select one of the software applications installed on the device. The device 230 includes logic 242 (e.g., communication logic for communications), a cache store 244 for storing data, messages, etc., a graphical user interface module 246 for generating graphical user interfaces on a display of the device, and device functionality 248 for determining device and connection capabilities (e.g., type of connection (e.g., 4G LTE, 3G, WiFi, WiMax, etc.), bandwidth of connection, location of device, and type of device, etc. Progress management server 260 includes an application communication interface 262, data monitoring module 264, progress management engine module 266, processing logic 268, progress management coordinator 270, and progress management data store 280. In one embodiment, the progress management application 252 or other applications 231 and a progress management server 260 communicate with each other over various networks and network configurations as discussed above in FIG. 1.

The graphical user interface module 246 is responsible for generating an interface for a user including any interfaces for the applications of the device 230. In embodiments discussed herein, the progress management application 252 or applications 231 may generate the application interface as a web page, a standalone application, or a mobile application, based upon the type of computing system upon which the application is executed. In one example, a progress management application 252 receives a user request to register with progress management server 260, and for the creation of a new progress management system. In one embodiment, the request includes user specification of a username and password to be associated with the progress management system, as well as login credentials for one or more electronic communication systems 205. In another example, upon initiation of a third party service application 231, a user provides authentication information for access to the third party service application with a hosted web page that also includes features and functionality of the progress management server for managing processes (e.g., customer management, onboarding process for employees, business development, etc.) for an organization of the user. In this example, the user does not need to have a separate account with the PM application or server.

The logic 242 includes a communication interface for transmitting communications (e.g., requests, usernames, and authentication credentials, etc.) to the application communication interface 262 of the progress management server 260. In one embodiment, the communication interface and application communication interface 262 communicate with one another using standard communications protocols, such as HTTP, HTTPS, etc. Additionally, the data exchanged between the communication interface and application communication interface 262 may be exchanged as a single message, or a series of messages.

Application communication interface 262 provides the request, the user access credentials and the progress management username/password combination to progress management coordinator 270. Progress management coordinator 270 provisions storage space within progress management data store 280 for the new progress management system to be created for the user.

Progress management coordinator 270 further provides the user's authentication credentials for the various electronic communications systems to data monitoring module 264. The data monitoring module 264 utilizes the user's authentication credentials to access the electronic communication systems 205 via network 202 or locally (as indicated by dashed line). Initially, data monitoring module 264 obtains all, or at least a portion, of the user's past communication activities on each of the electronic communication systems 205. These communications are provided to progress management module 266 to analyze the electronic communications. The processing logic 268 can execute instructions for software of the PM server 260 include the module 266.

Progress management module 266 provides the results to progress management coordinator 270 for storage in a contacts/relationships database 286 in progress management data store 280. In one embodiment, when data monitoring module 264 passes the obtained electronic communications to progress management module 266, the electronic communications are also passed to progress management coordinator 270 for storage in a database 282 in progress management data store 280.

In one embodiment, progress management module 266 further determines one or more processes to associate with the user based on the user's communications. As discussed herein, the communications may indicate the user engaging in a sales process with a first group of users, engaging in a recruiting process with a second group of users, etc. The progress management coordinator 270 stores these determined processes, and the additional user contacts associated with these processes in database 284 and 286.

In the embodiments discussed herein, the data displayed by graphical user interface module 246 can be configured for display based on characteristics of a device, such as screen size, resolution, dimensions, etc. Furthermore, the display may graphically illustrate a process, communications within the process, and a filtered result of the communications (e.g., display indicating an appropriate stage within a process).

In one embodiment, processes may be multi-user processes within an organization. In this embodiment, contacts, relationships, messages, suggestions, etc. may be accessible to other participants in a process (i.e., other sales people in an organization, specific users participating in a recruitment process, etc.). In one embodiment, progress management module 266 may further refine or add to contact details by leveraging contact data extracted from several users and several different communication services. Similarly, suggestions may be culled from one user's communications within a process, and the suggestion propagated to additional users.

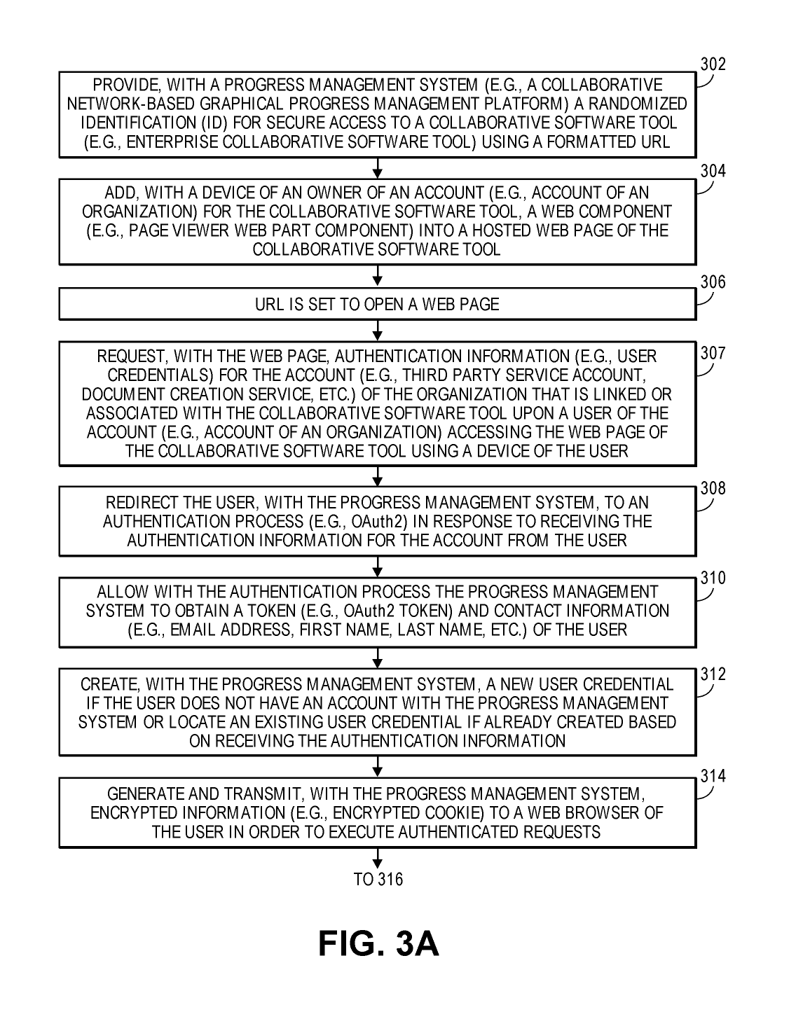

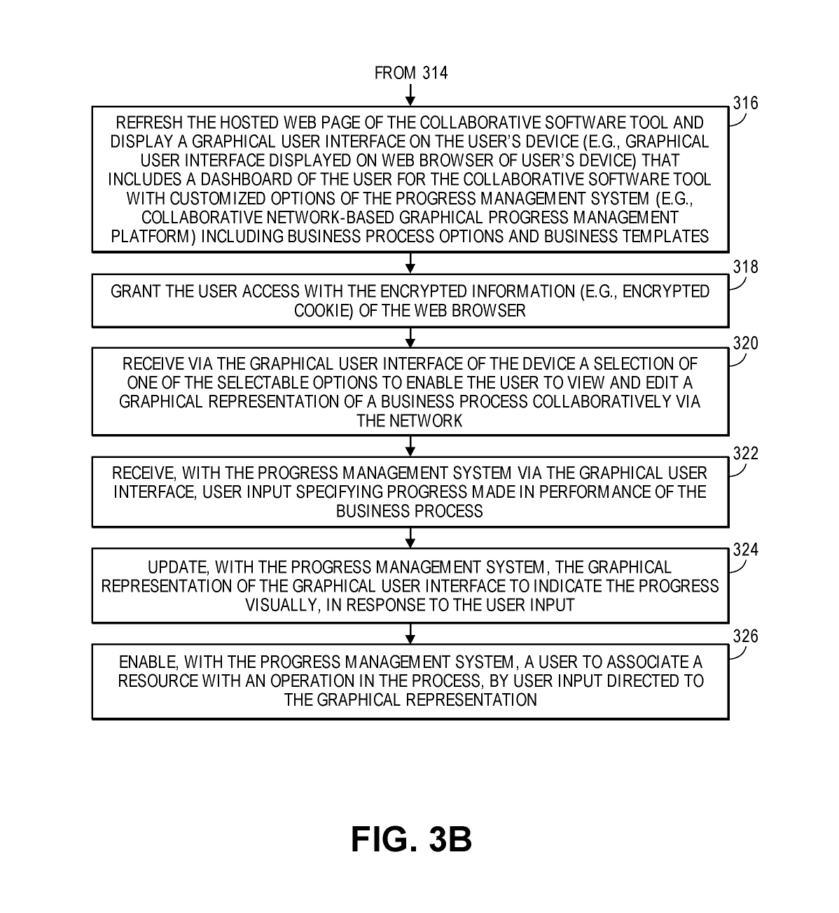

FIGS. 3A and 3B illustrate flow diagrams of operations for a progress management system for providing integration of progress management functionality with third party services (e.g., collaborative software tools, social media, etc.) in accordance with one embodiment. The operational flow of the progress management system may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 300 by executing instructions of any tools or modules of computing devices or servers (e.g., the PM server 110, PM server 260). The progress management system communicates with devices of users, electronic communication systems, and third party services via a network (e.g., network 102, 202).

The progress management system (e.g., a collaborative network-based graphical progress management platform) provides secure access to a collaborative software tool (e.g., enterprise collaborative software tool) and provides a formatted URL at operation 302. In one example, the progress management system generates a randomized identification (ID) for the secure access to the collaborative software tool and the formatted URL (e.g., https://progress management system/dashboard/collaborative software tool/ORG_UUID) provides access to the collaborative software tool. An owner of an account (e.g., account of an organization) for the collaborative software tool adds a web component (e.g., page viewer web part component) into a hosted web page of the collaborative software tool at operation 304. In one example, the web part component is implemented with a web browser that supports a HTML Iframe element. The account may be established for an organization or company. The hosting of the account with the hosted web page can be cloud based or on-premise of the organization or company.

The web part component is set to open the provided URL (e.g., https://progress management system/dashboard/collaborative software tool/ORG_UUID) at operation at 306. A user of the account (e.g., account of an organization) visits a web page of the collaborative software tool using a device of the user and this web page requests authentication information (e.g., user credentials) for the account (e.g., third party service account, document creation service, etc.) of the organization that is linked or associated with the collaborative software tool. In one example, the progress management system which can host the account provides a graphical user interface on the user's device at operation 306 for the user that is associated with an organization or group of users.

At operation 308, the progress management system redirects the user to an authentication process (e.g., OAuth2) in response to receiving the authentication information for the account from the user. The authentication process allows the progress management system to obtain a token (e.g., OAuth2 token) and contact information (e.g., email address, first name, last name, etc.) of the user at operation 310. The authentication process enables the progress management system to obtain limited access to an HTTP service, either on behalf of a resource owner and the HTTP service, or by allowing the progress management system to obtain access on its own behalf. In one example, access tokens are credentials used to access protected resources. Tokens represent specific scopes and durations of access, granted by a resource owner and enforced by a resource server and authentication server.

At operation 312, the progress management system creates a new user credential if the user does not have an account with the progress management system or locates an existing user credential if already created based on receiving the authentication information.

At operation 314, the progress management system generates and transmits encrypted information (e.g., encrypted cookie) to a web browser of the user in order to execute authenticated requests. At operation 316, the hosted web page of the collaborative software tool refreshes and displays a graphical user interface on the user's device (e.g., graphical user interface displayed on web browser of user's device) that includes a dashboard of the user for the collaborative software tool with customized options of the progress management system (e.g., collaborative network-based graphical progress management platform) including business process options and business templates. The dashboard of the user corresponds to the randomized ID that was created at operation 302 for the account of organization.

At operation 318, the user access is granted with the encrypted information (e.g., encrypted cookie) of the web browser. At operation 320, the progress management system receives via the graphical user interface a selection of one of the selectable options to enable the user to view and edit a graphical representation of a business process collaboratively via the network. At operation 322, the progress management system receives via the graphical user interface from the user or at least one of the plurality of users of the account of the organization, user input specifying progress made in performance of the business process. At operation 324, the progress management system updates the graphical representation of the graphical user interface to indicate the progress visually, in response to the user input. At operation 326, the progress management system enables a user to associate a resource with an operation in the process, by user input directed to the graphical representation. The resource comprises at least one of a document, a hyperlink, a graphical object, a still image, an audio clip or a video clip.

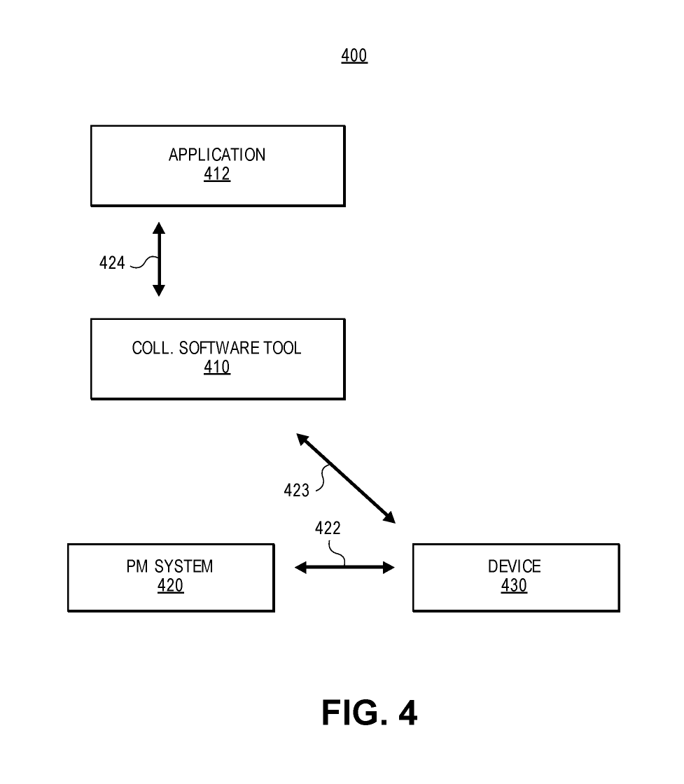

FIG. 4 illustrates a block diagram showing how a progress management system interacts with a collaborative software tool in accordance with one embodiment. The operational flow of the progress management system 420 may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 300 by executing instructions of any tools or modules of computing devices or servers (e.g., the PM server 110, PM server 260, PM system 420). The progress management system communicates with devices of users, electronic communication systems, and third party services via a network (e.g., network 102, 202).

The progress management system 420 (e.g., a collaborative network-based graphical progress management platform) provides secured access to a collaborative software tool 410 (e.g., enterprise collaborative software tool, SHAREPOINT™) and provides a formatted URL to a device 430 using a communication link 432. In one example, the progress management system 420 generates a randomized identification (ID) for the secured access to the collaborative software tool and the formatted URL (e.g., https://progress management system/dashboard/collaborative software tool/ORG_UUID) provides access to the collaborative software tool. An owner of an account (e.g., account of an organization) for the collaborative software tool adds a web component (e.g., page viewer web part component) into a hosted web page of the collaborative software tool. In one example, the web part component is implemented with a web browser that supports a HTML Iframe element. The account may be established for an organization or company. The hosting can be cloud based or on-premise of the organization or company.

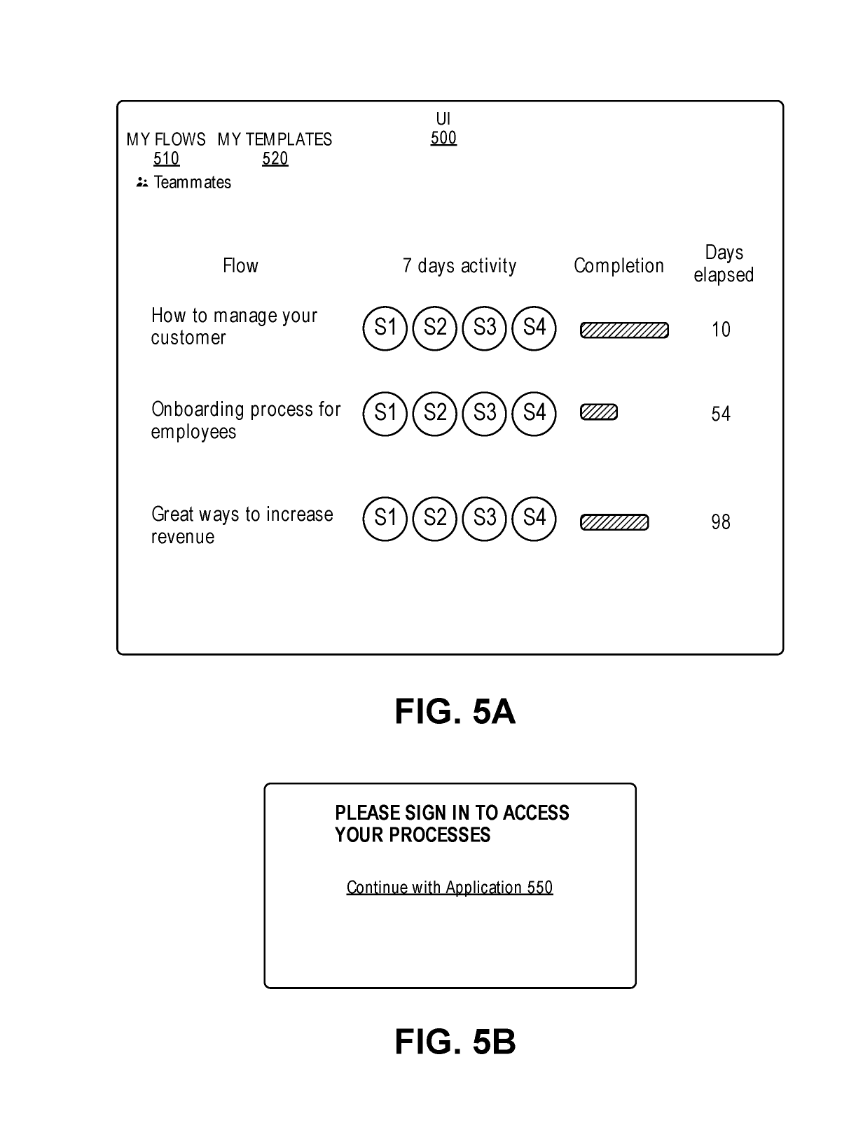

The web part component is set to open the provided URL (e.g., https://progress management system/dashboard/collaborative software tool/ORG_UUID) as illustrated in user interface 500 of FIG. 5A in accordance with one embodiment. The user interface 500 includes selectable my flows option 510 to access business process flows, my templates option 520 to access templates for business processes, and different examples of flows (e.g., how to manage you customer, onboarding process for employees, great ways to increase revenue). Each flow includes a high level summary that illustrates third party service icons (e.g., S1, S2, S3, S4, software as a service (SaaS) tools), progress bar showing a level of completion for the flow, and days elapsed since initiation of the flow.

A user visits a web page (e.g., user interface 540 of FIG. 5B) of the collaborative software tool 410 and this web page requests authentication information (e.g., user credentials) for an account (e.g., third party service account, document creation service, etc.) of the user that is linked or associated with the collaborative software tool 420. In one example, the user can access the user interface 500 upon providing authentication information to the user interface 540 using continue with Application 550 option. The application 550 may be linked or associated with the collaborative software tool 410 using communication link 424.

Upon receiving the authentication information using communication link 422, the progress management system redirects the user to an authentication process (e.g., OAuth2) using communication link 423. The authentication process allows the progress management system to obtain a token (e.g., OAuth2 token) and contact information (e.g., email address, first name, last name, etc.) of the user. The authentication process enables the progress management system to obtain limited access to an HTTP service, either on behalf of a resource owner and the HTTP service, or by allowing the progress management system to obtain access on its own behalf. In one example, access tokens are credentials used to access protected resources. Tokens represent specific scopes and durations of access, granted by a resource owner and enforced by a resource server and authentication server.

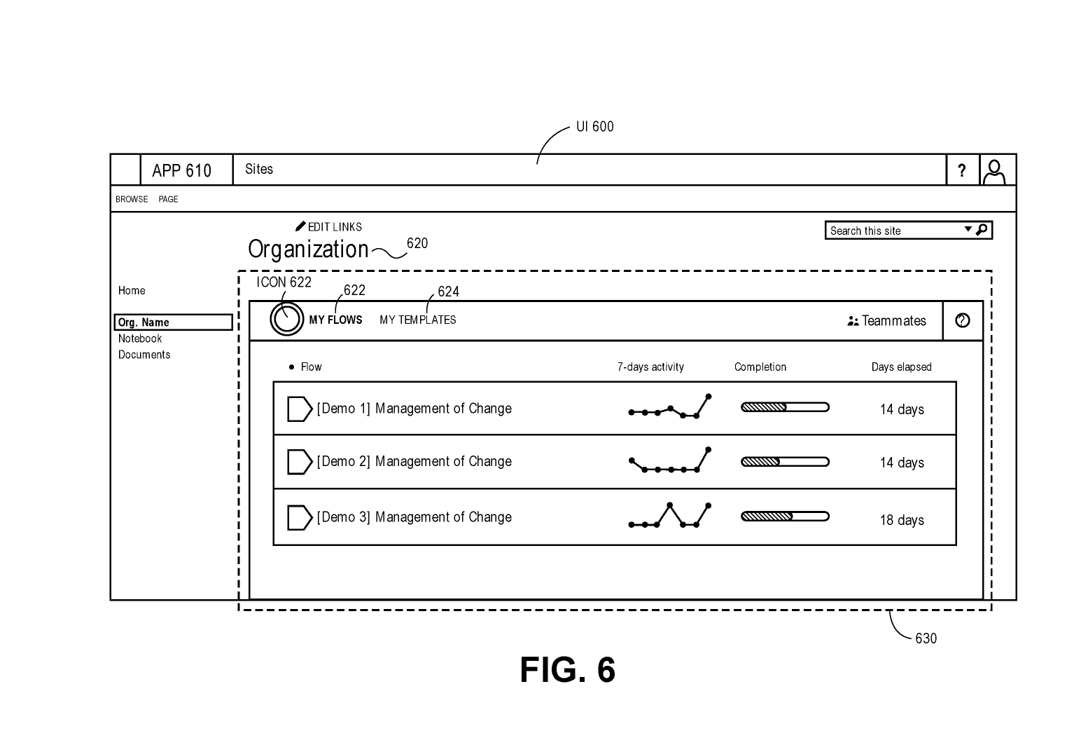

Next, the progress management system creates a new user credential if the user does not have an account with the progress management system or locates an existing user credential based on receiving the authentication information. The progress management system generates and transmits encrypted information (e.g., encrypted cookie) to a web browser of the device of the user in order to execute authenticated requests. The web page of the collaborative software tool refreshes and displays a graphical user interface 600 as illustrated in FIG. 6 that includes a dashboard of the user for the collaborative software tool with customized options of the collaborative network-based graphical progress management platform including business process options 622 and business templates 624. The user interface 600 includes the web component 630 for dynamically providing features of the progress management system 420 in real time (e.g., less than 5 seconds, less than 2 seconds, less than 1 second). An organization name 620 and icon 622 are included in the user interface 600. My flows 622 is selected in user interface 600 and shows one or more flows (e.g., demonstrations 1-3 for a management of change flow), 7-day activity in graphical form, completion progress, and days elapsed since initiation of the flow. The progress management system provides updates for operations and work actions (e.g., view, completion status, work from integrated service, assignment) in real time to user interfaces (e.g., user interface 500, 600, etc.) upon receiving any type of update of an operation or work action.

The functionality of the progress management system can be implemented in a server system (e.g., PM server 110, PM server 260), or in each client device (e.g., devices 140, 130-1-130-N, 230) or it may be distributed between the server(s) and the client devices. Within a given device, the features and functionality can be implemented by one or more microprocessors executing computer program code stored in a memory and accessing data stored in a memory. The functionality of the progress management system or any client device can be physically implemented in a single physical enclosure or distributed among multiple physical enclosures, which may be connected via a network.

Network 102 or 202 represents any one or more of various types of networks, which may be wired or wireless or a combination thereof. The network may include, for example, a personal area network (PAN), local area network (LAN), wide area network (WAN), metropolitan area networks (MAN), global internetwork such as the Internet, cellular telecommunications network, etc.

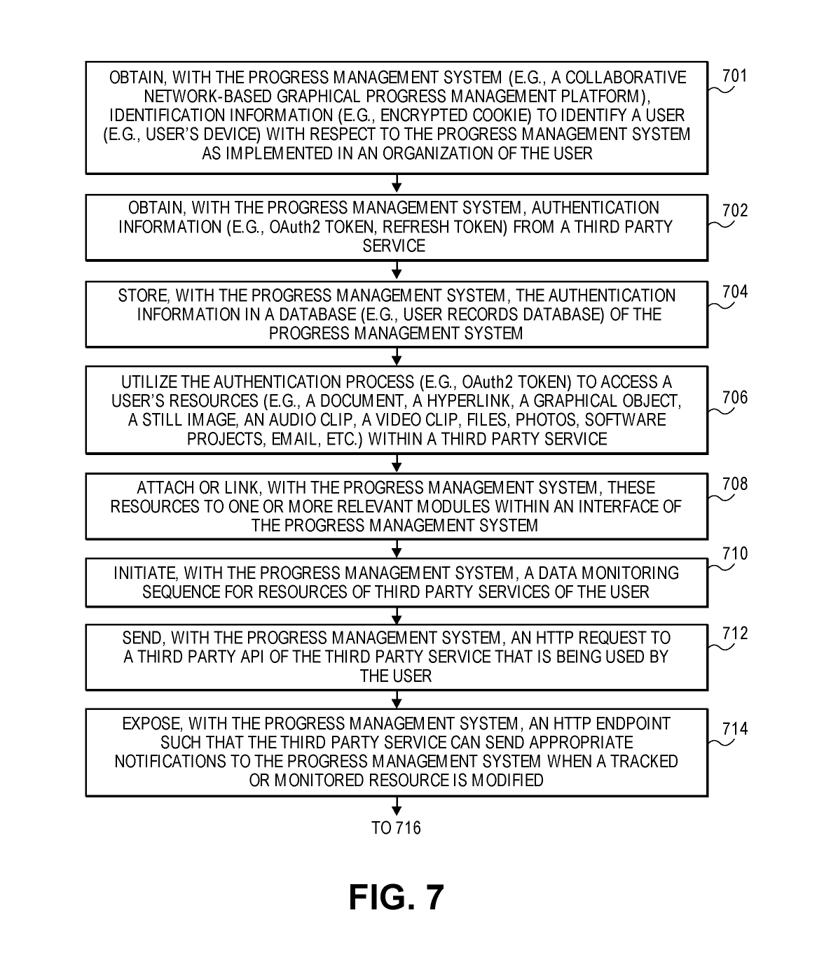

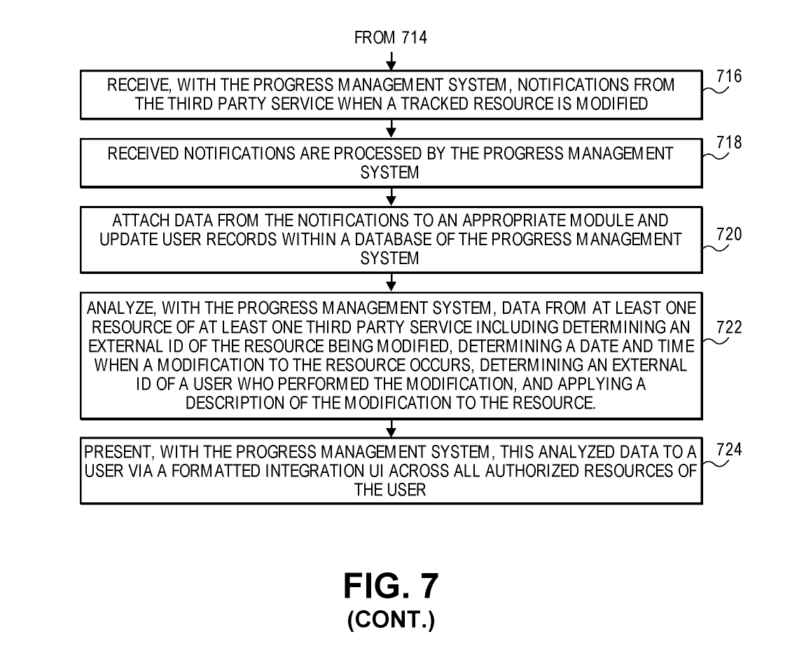

FIG. 7 illustrates a flow diagram of operations for a progress management system for providing data monitoring and data analysis of third party services (e.g., SaaS tools, collaborative software tools, social media, etc.) in accordance with one embodiment. The operational flow of the progress management system may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 700 by executing instructions of any tools or modules of computing devices or servers (e.g., the PM server 110, PM server 260). The progress management system communicates with devices of users, electronic communication systems, and third party services via a network (e.g., network 102, 202). A user's device includes a web browser. An encrypted cookie on the user's web browser includes sufficient information to identify the user against a progress management system that is integrated with a discrete organization having a plurality of users. Typically, an origin server sends state information (e.g., encrypted cookie) to a user's device and the user's device returns state information to the origin server. To store state, the origin server includes a Set-Cookie header in an HTTP response. In subsequent requests, the user's device returns a Cookie request header to the origin server. The Cookie header contains cookies the user's device received in previous Set-Cookie headers.

At operation 701, the progress management system (e.g., a collaborative network-based graphical progress management platform) obtains identification information (e.g., encrypted cookie) to identify a user (e.g., user's device) with respect to the progress management system as implemented in an organization of the user. For example, the organization may have an account established with the progress management system. The progress management system obtains authentication information (e.g., OAuth2 token, refresh token) from a third party service at operation 702. The progress management system stores the authentication information in a database (e.g., user records database) of the progress management system at operation 704. The authentication process (e.g., OAuth2 token, refresh token) enables the progress management system to obtain limited access to an HTTP service, either on behalf of a resource owner and the HTTP service, or by allowing the progress management system to obtain access on its own behalf. In one example, access tokens are credentials used to access protected resources. Tokens represent specific scopes and durations of access, granted by a resource owner and enforced by a resource server and authentication server. Refresh tokens are credentials used to obtain access tokens. Refresh tokens are issued to a client by an authorization server and are used to obtain a new access token when the current access token becomes invalid or expires, or to obtain additional access tokens with identical or narrower scope.

At operation 706, the progress management system uses the authentication process (e.g., OAuth2 token) to access a user's resources (e.g., a document, a hyperlink, a graphical object, a still image, an audio clip, a video clip, files, photos, software projects, email, etc.) within a third party service. At operation 708, the progress management system attaches or links these resources to one or more relevant modules within an interface of the progress management system. At operation 710, the progress management system initiates a data monitoring sequence for third party services (e.g., DROPBOX™, BOX™, DRIVE™, GITHUB™, etc.) of resources of the user.

At operation 712, the progress management system sends an HTTP request to a third party API of the third party service that is being used by the user. At operation 714, the progress management system exposes an HTTP endpoint such that the third party service can send appropriate notifications to the progress management system when a tracked (monitored) resource is altered, modified, or changed. At operation 716, the progress management system receives notifications from the third party service when a tracked resource is altered, modified, or changed. At operation 718, received notifications are processed by the progress management. Data from the notifications is attached to an appropriate module and user records are updated within a database of the progress management system in real time at operation 720.

At operation 722, the progress management system analyzes data in real time from at least one resource of at least one third party service. Analyzing the data may include determining an external ID of the resource being modified, determining a date and time when a modification to the resource occurs, determining an external ID of a user who performed the modification, and applying a description of the modification to the resource. At operation 724, the progress management system presents this analyzed data in real time to a user via a formatted integration UI across all authorized resources of the user.

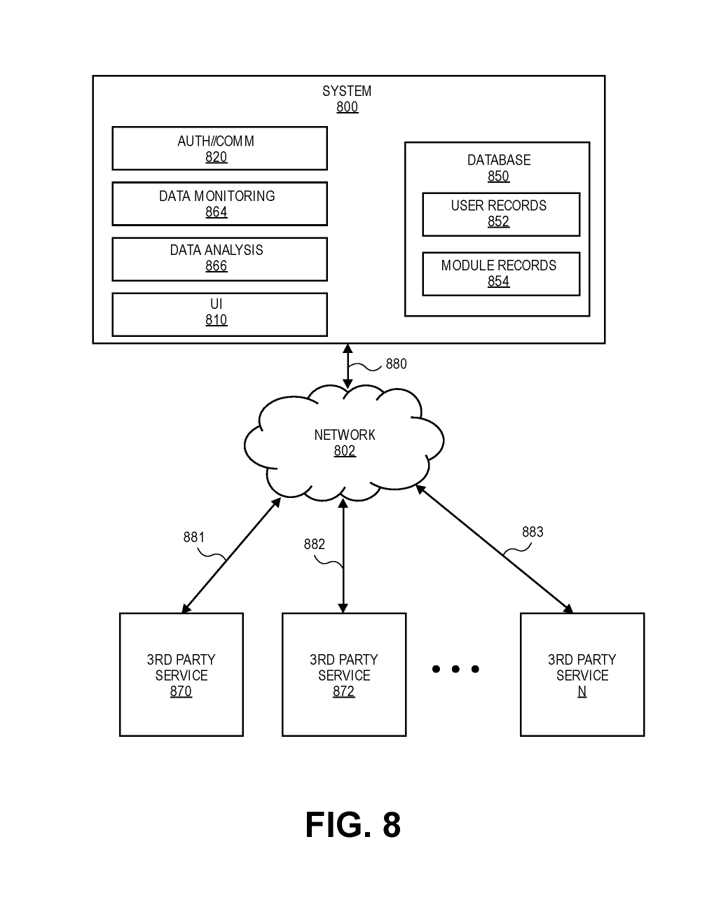

FIG. 8 illustrates a block diagram of a progress management system for providing data monitoring and data analysis of third party services (e.g., SaaS tools, collaborative software tools, social media, etc.) in accordance with one embodiment. The operational flow (e.g., method 700) of the progress management system may be executed by an apparatus or system, which includes processing circuitry or processing logic. The processing logic may include hardware (circuitry, dedicated logic, etc.), software (such as is run on a general purpose computer system or a dedicated machine or a device), or a combination of both.

The progress management system 800 (e.g., a collaborative network-based graphical progress management platform) utilizes an authentication and communication module 820 to obtain authentication information (e.g., OAuth2 token, refresh token) from at least one third party service 870, 872, . . . N using a communication link 880 to connect to a network 802 and then at least one of communication links 881, 882, 883 to communicate with the third party services. The progress management system 800 stores the authentication information in a database 850 (e.g., user records database 852) of the progress management system.

The progress management system uses the authentication process (e.g., OAuth2 token) to access a user's resources (e.g., a document, a hyperlink, a graphical object, a still image, an audio clip, a video clip, files, photos, software projects, email, etc.) within a third party service. The progress management system attaches or links these resources to one or more relevant modules stored in module records 854 of the database 850 of the progress management system. Then, a data monitoring module 864 initiates a data monitoring sequence for third party services 870, 872, . . . N of the user.

The authentication and communication module 820 sends an HTTP request to a third party API of the third party service that is being used by the user. The authentication module exposes an HTTP endpoint such that the third party service can send appropriate notifications to the progress management system when a tracked resource is altered, modified, or changed. The progress management system receives notifications from the third party service when a tracked resource is altered, modified, or changed. Received notifications are processed by a data analysis module 866 of the progress management. Data from the notifications is attached to an appropriate module of module records 854 and user records 852 are updated within a database 850 of the progress management system in real time upon receiving notifications.

The data analysis module 866 analyzes data from at least one resource of at least one third party service. Analyzing the data may include determining an external ID of the resource being modified, determining a date and time when a modification to the resource occurs, determining an external ID of a user who performed the modification, and applying a description of the modification to the resource. The progress management system presents this analyzed data in real time to a device of a user via a formatted integration UI 810 across all authorized resources of the user.

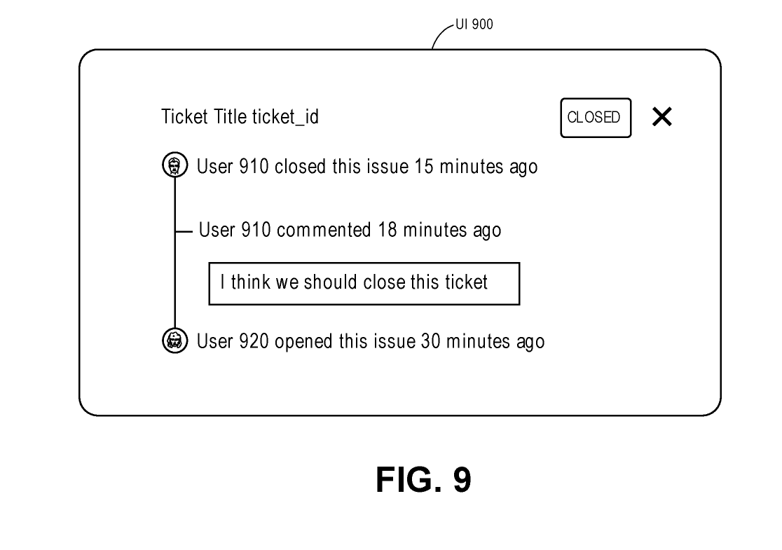

FIG. 9 illustrates an example of a user interface presented by the progress management system when a monitored resource of a third party service is changed in accordance with one embodiment. The progress management system is monitoring a resource of a third party service (e.g., online project hosting service) for a user. The third party service sends a notification of a modification of a resource to the progress management system which analyzes the notification, generates analyzed data, and then presents the user interface (UI) 900 to a device of the user in real time. This UI 900 displays a ticket title with a ticket id 930, a user 920 opening an issue at a first time period (e.g., 30 minutes ago), a user 910 commenting on this ticket at a second time period (e.g., 18 minutes ago), and then the user 910 closing this issue at a third time period (e.g., 15 minutes).

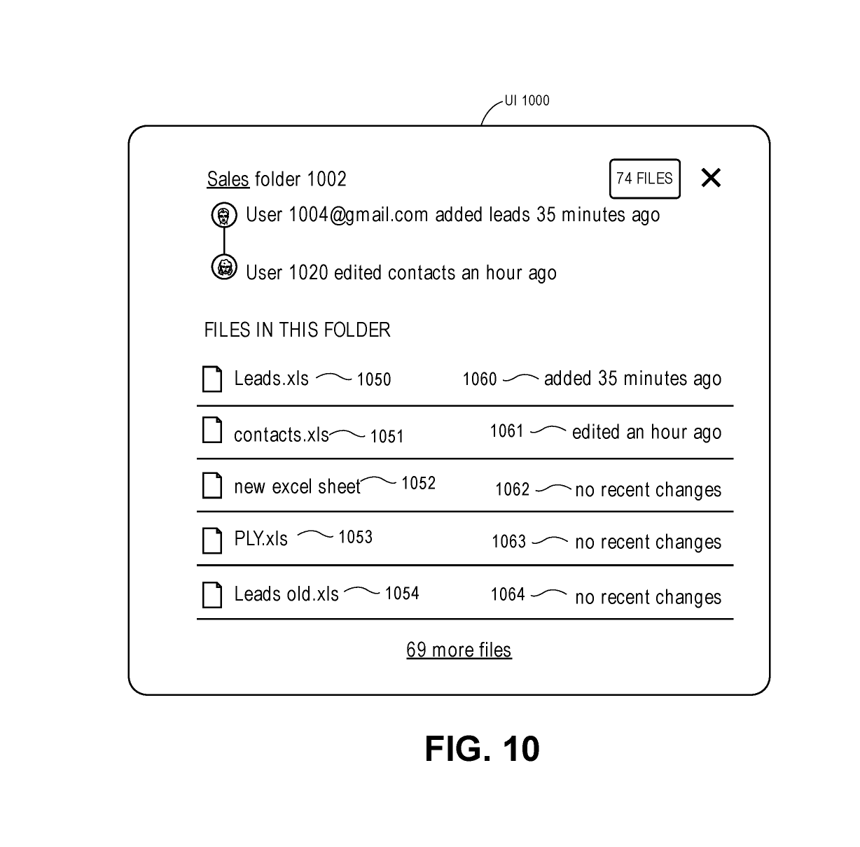

FIG. 10 illustrates another example of a user interface presented by the progress management system when a monitored resource of a third party service is changed in accordance with one embodiment. The progress management system is monitoring a resource of a third party service (e.g., online storage service) for a user. The third party service sends a notification of a modification of a resource (e.g., edited contacts, new file, etc.) to the progress management system which analyzes the notification, generates analyzed data, and then presents the user interface (UI) 1000 to a device of user in real time. This UI 1000 displays a Sales folder 1002 that lists users 1004 and 1020. The user 1004 added a leads file at a first time period (e.g., 35 minutes ago). A user 1020 (may be same as user 920) edited a contacts file at a second time period (e.g., an hour ago). The UI 1000 also dynamically in real time displays a list of files 1050-1054 and associated status information 1060-1064 for a corresponding file.

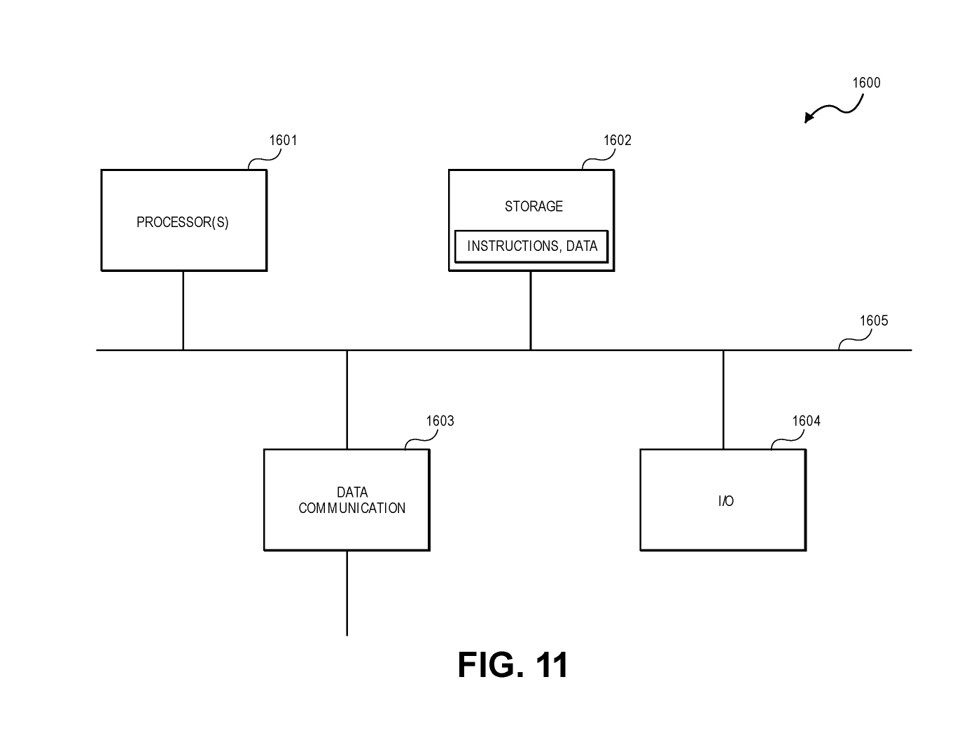

FIG. 11 shows an example, at a high level, of the internal architecture of a processing system 1600 representing any of the devices mentioned above, e.g., the PM server or any of the client devices in one embodiment. In the illustrated embodiment, the processing system 1600 includes one or more processors 1601, one or more data storage devices 1602, a data communication device 1603, and one or more input output (I/O) devices 1604. These components are connected to each other, either directly or indirectly, through an interconnect system 1605, which can include any one or more of various types of connections, including one or more point-to-point connections, buses, adapters, etc.

The processor(s) 1601 control the operation of the processing system 1600. Each processor 1601 can be or include a programmable microprocessor, microcontroller, application specific integrated circuit (ASIC), programmable logic device (PLD), or the like, or combination thereof. Each processor 1601 can execute instructions and/or operate upon data stored in storage device(s) 1602. Each storage device 1602 (e.g., machine-accessible non-transitory medium) can include any of various forms of storage, including random access memory (RAM), read-only memory (ROM), flash memory, hard disk drive, digital versatile disk (DVD) drive, removable storage such as one or more USB drives, or the like, or combination thereof.

In one example, a storage medium (e.g., a machine-accessible non-transitory medium) contains executable computer program instructions which when executed by processor(s) cause the system to perform any of the methods discussed herein. While the machine-accessible non-transitory medium 1602 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media.

Data communication device 1603 enables the processing system 1603 to communication with other processing systems over a network, such as interconnect 1503 in FIG. 15. Data communication device 1603 may be or include, for example, a convention cable modem, digital subscriber line (DSL) modem, Ethernet adapter, wireless transceiver, or the like.

In one embodiment, software for providing the client-side functionality can be coded in JavaScript. In such an embodiment, software for implementing the server-side functionality may be coded in, for example, Objective-C, Java, or a combination thereof.

The server(s) may include one or more databases to store data, such as user account data, data input by users (e.g., data defining processes, content associated with processes, settings, privileges), data defining the various user interface elements. Alternatively, at least some of that data can be stored, or at least cached, on one or more clients.

### Data Dictionary

The following describes the various data entities that are used in one embodiment of the progress management system.

1. prog_template

This is a standard table with the base fields every table should have.

### Fields:

| Name | Type | Description | Comments |
|---|---|---|---|
| id | INT(11) | PK | |
| parameters | LONGTEXT | optional JSON | nullable |
| | | configuration object | |
| created | TIMESTAMP | the object's | |
| | | created date | |
| updated | TIMESTAMP | the object's date | |
| | | last modified | |
| created_by | INT(11) | FK to prog_user | |
| | | table | |
| updated_by | INT(11) | FK to prog_user | |
| | | table | |
| active | TINYINT(1) | BOOLEAN, is active? | |
| status | INT(11) | FK to status table | |

2. prog_users

This is a generic users table.

### Fields:

| Name | Type | Description | Comments |
|---|---|---|---|
| id | INT(11) | | |
| name | TEXT | | |
| username | TEXT | | |
| email | TEXT | | |
| password | TEXT | | |
| type | TEXT | | |
| block | TINY INT(1) | BOOLEAN | |
| send_email | TINY INT(1) | BOOLEAN | |
| register_date | DATETIME | | |
| last_visit_date | DATETIME | | |
| active | TINYINT(1) | BOOLEAN | |
| parameters | LONGTEXT | optional JSON | nullable |
| | | configuration object | |
| created | TIMESTAMP | | |
| updated | TIMESTAMP | | |
| status | INT(11) | | |
| created_by | INT(11) | FK to prog_user | |

3. prog_organizations

prog_organization defines a company of organization that many collaborators belong to.

### Fields:

| Name | Type | Description | Comments |
|---|---|---|---|
| id | INT(11) | PK | |
| name | TEXT | | |
| description | LONGTEXT | | nullable |
| size | TEXT | | nullable |
| industry | TEXT | | nullable |
| parameters | LONGTEXT | optional JSON | nullable |
| | | configuration object | |
| created | TIMESTAMP | the object's | |
| | | created date | |
| updated | TIMESTAMP | the object's date | |
| | | last modified | |
| created_by | INT(11) | FK to prog_user's | |
| updated_by | INT(11) | FK to prog_user | |
| | | table | |
| active | TINYINT(1) | BOOLEAN, is active? | |
| status | INT(11) | FK to status table | |

4. prog_addresses

This is represents a user or company address.

### Fields:

| Name | Type | Description | Comments |
|---|---|---|---|
| id | INT(11) | PK | |
| user_id | INT(11) | FK to prog_user | nullable |
| | | table | |
| organization_id | INT(11) | FK to prog_organization | nullable |
| | | table | |
| type | TEXT | | |
| address_1 | TEXT | | nullable |
| address_2 | TEXT | | nullable |
| address_3 | TEXT | | nullable |
| city | TEXT | | nullable |
| state | TEXT | | nullable |
| zip | TEXT | | nullable |
| phone | TEXT | | nullable |
| country | TEXT | | nullable |
| description | LONGTEXT | | nullable |
| name | TEXT | | nullable |
| parameters | LONGTEXT | optional JSON | nullable |
| | | configuration object | |
| created | TIMESTAMP | the object's | |
| | | created date | |
| updated | TIMESTAMP | the object's date | |
| | | last modified | |
| created_by | INT(11) | FK to prog_user's | |
| updated_by | INT(11) | FK to prog_user | |
| | | table | |
| active | TINYINT(1) | BOOLEAN, is active? | |
| status | INT(11) | FK to status table | |

5. prog_flows

prog_flow objects are at the top of the process hierarchy. All configuration data related to the entire process is contained within this table, along with the title, description, etc.

### Fields:

| Name | Type | Description | Comments |
|---|---|---|---|
| id | INT(11) | PK | |
| name | TEXT | | |
| description | LONGTEXT | | nullable |
| title | TEXT | | nullable |
| instructions | LONGTEXT | | nullable |
| allow_comments | TINYINT(1) | BOOLEAN | |
| allow_collaboration | TINYINT(1) | BOOLEAN | |
| parameters | LONGTEXT | optional JSON | nullable |
| | | configuration object | |
| created | TIMESTAMP | the object's | |
| | | created date | |
| updated | TIMESTAMP | the object's date | |
| | | last modified | |
| created_by | INT(11) | FK to prog_user's | |
| updated_by | INT(11) | FK to prog_user | |
| | | table | |
| active | TINYINT(1) | BOOLEAN, is active? | |
| status | INT(11) | FK to status table | |

6. prog_rows

prog_row objects represent the process's container for “steps”. Each row corresponds with a particular activity, department, or subject matter within a process. prog_row objects group prog_steps logically according to purpose or goal.

### Fields:

| Name | Type | Description | Comments |
|---|---|---|---|
| id | INT(11) | PK | |
| flow_id | INT(11) | FK to prog_flow | |
| | | table | |
| name | TEXT | | |
| description | LONGTEXT | | nullable |
| title | TEXT | | nullable |
| instructions | LONGTEXT | | nullable |
| allow_comments | TINYINT(1) | BOOLEAN | |
| allow_collaboration | TINYINT(1) | BOOLEAN | |
| position | INT(11) | sets the position | |
| | | of the step relative | |
| | | to other steps in a | |
| | | flow's row | |
| parameters | LONGTEXT | optional JSON | nullable |
| | | configuration object | |
| created | TIMESTAMP | the object's | |
| | | created date | |
| updated | TIMESTAMP | the object's date | |
| | | last modified | |
| created_by | INT(11) | FK to prog_user's | |
| updated_by | INT(11) | FK to prog_user | |
| | | table | |
| active | TINYINT(1) | BOOLEAN, is active? | |
| status | INT(11) | FK to status table | |

7. prog_steps

prog_step objects represent an individual “node” within a row around which content is created and collaborated on. Prog_steps represent the individual steps within a row that constitute a process.

### Fields:

| Name | Type | Description | Comments |
|---|---|---|---|
| id | INT(11) | PK | |
| flow_id | INT(11) | FK on prog_flow | |
| | | table | |
| row_id | INT(11) | FK to prog_row | nullable |
| | | table | |
| name | TEXT | | |
| description | LONGTEXT | | nullable |
| title | TEXT | | nullable |
| instructions | LONGTEXT | | nullable |
| estimated_time | FLOAT | | nullable |
| estimated_cost | FLOAT | | nullable |
| progress_by_date | DATETIME | | nullable |
| complete_by_date | DATETIME | | nullable |
| position | INT(11) | sets the position | |
| | | of the step relative | |
| | | to other steps in a | |
| | | flow's row | |
| allow_comments | TINYINT(1) | BOOLEAN | |
| allow_collaboration | TINYINT(1) | BOOLEAN | |
| parameters | LONGTEXT | optional JSON | nullable |
| | | configuration object | |
| created | TIMESTAMP | the object's | |
| | | created date | |
| updated | TIMESTAMP | the object's date | |
| | | last modified | |
| created_by | INT(11) | FK to prog_user's | |
| updated_by | INT(11) | FK to prog_user | |
| | | table | |
| active | TINYINT(1) | BOOLEAN, is active? | |
| status | INT(11) | FK to status table | |
| estimated_time_type | TEXT | | |
| estimated_cost_type | TEXT | | |
| explanation | LONGTEXT | | |

8. prog_contents

prog_content objects represent all content that can be associated at the flow, row, step, comment, and notes level. Content will be of the types defined in the prog_content_type table. All content items have a JSON object defined allowing for flexible configurations of content items.

### Fields:

| Name | Type | Description | Comments |
|---|---|---|---|
| id | INT(11) | PK | |
| type | INT(11) | FK to prog_content_type | |
| flow_id | INT(11) | FK on prog_flow | |
| parameters | LONGTEXT | stores a JSON object with | nullable |
| | | data relevant to content | |
| | | object | |
| content_binary | LONGBLOB | binary data | nullable |
| content_text | LONGTEXT | | nullable |
| created | TIMESTAMP | the object's | |
| | | created date | |
| updated | TIMESTAMP | the object's date | |
| | | last modified | |
| created_by | INT(11) | FK to prog_user's | |
| updated_by | INT(11) | FK to prog_user | |
| | | table | |
| active | TINYINT(1) | BOOLEAN, is active? | |
| status | INT(11) | FK to status table | |

9. prog_content_types

prog_content_type table is simply a list of values for all of the types of content that can be supported in the system.

The likely values of this table are: Video, Image, Map, Profile Page, Tweet, Weblink, URL, Source Document.

### Fields:

| Name | Type | Description | Comments |
|---|---|---|---|
| id | INT(11) | PK | |
| name | TEXT | | |
| description | LONGTEXT | | nullable |
| created | TIMESTAMP | the object's | |
| | | created date | |
| updated | TIMESTAMP | the object's date | |
| | | last modified | |
| created_by | INT(11) | FK to prog_user's | |
| updated_by | INT(11) | FK to prog_user | |
| | | table | |
| active | TINYINT(1) | BOOLEAN, is active? | |

10. prog_content_associations

This associates a piece of content with a flow, row, or step. The type of content and how it relates to its associated flow, row, or step is defined in the prog_content_association_type table.

### Fields:

| Name | Type | Description | Comments |
|---|---|---|---|
| id | INT(11) | PK | |
| type | INT(11) | FK on prog_con- | not null |
| | | tent_association_type | |
| flow_id | INT(11) | FK on prog_flow | nullable |
| row_id | INT(11) | FK on prog_row | nullable |
| step_id | INT(11) | FK on prog_step | nullable |
| comment_id | INT(11) | FK to prog_comment | nullable |
| note_id | INT(11) | FK to prog_note | nullable |
| description | LONGTEXT | | nullable |
| content_id | INT(11) | FK to prog_content | |
| parameters | LONGTEXT | stores a JSON object with | nullable |
| | | data relevant to content | |
| | | object | |
| created | TIMESTAMP | the object's | |
| | | created date | |
| updated | TIMESTAMP | the object's | |
| | | date last modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |

Unless contrary to physical possibility, it is envisioned that (i) the methods/operations described herein may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A computer implemented method comprising:
obtaining identification information, with a progress management system, to identify a user of an organization with respect to the progress management system;
obtaining authentication information, with the progress management system, from at least one third party service of the user;
accessing resources of the user for the at least one third party service;
attaching or linking these resources to one or more relevant modules within an interface of the progress management system for the user; and
initiating a data monitoring sequence for the at least one third party service of the user.

2. The computer implemented method of claim 1, further comprising:
sending, with the progress management system, an HTTP request to the at least one third party service that is being used by the user; and
exposing, with the progress management system, an HTTP endpoint such that the at least one third party service can send appropriate notifications to the progress management system when a monitored resource is changed.

3. The computer implemented method of claim 2, further comprising:
receiving, with the progress management system, notifications from the at least one third party service when a monitored resource is changed; and
process notifications received by the progress management system.

4. The computer implemented method of claim 3, further comprising:
attach data obtained from the notifications to an appropriate module within an interface of the progress management system for the user; and
update user records within a database of the progress management system.

5. The computer implemented method of claim 4, further comprising:
analyzing, with the progress management system, data from at least one resource of at least one third party service, wherein analyzing the data includes determining an external ID of the at least one resource being modified, determining a date and time when a modification to the at least one resource occurs, determining an external ID of a user who performed the modification, and applying a description of the modification to the resource.

6. The computer implemented method of claim 5, further comprising:
presenting this analyzed data in real time to a device of the user via a formatted integration user interface across all authorized resources of the user which have been monitored and analyzed.

7. The computer implemented method of claim 1, wherein the progress management system comprises a collaborative network-based graphical progress management platform.

8. The computer implemented method of claim 1, wherein the resources comprise at least two of a document, a hyperlink, a graphical object, a still image, an audio clip, and a video clip.

9. A non-transitory machine-readable storage medium storing instructions that, when executed by a machine, cause the machine to perform a process that comprises:
obtaining identification information, with a progress management system, to identify a user of an organization with respect to the progress management system;
obtaining authentication information, with the progress management system, from at least one third party service of the user;
accessing resources of the user for the at least one third party service;
attaching or linking these resources to one or more relevant modules within an interface of the progress management system for the user; and
initiating a data monitoring sequence for the at least one third party service of the user.

10. The non-transitory machine-readable storage medium of claim 9, the process further comprising:
sending, with the progress management system, an HTTP request to the at least one third party service that is being used by the user; and
exposing, with the progress management system, an HTTP endpoint such that the at least one third party service can send appropriate notifications to the progress management system when a monitored resource is changed.

11. The non-transitory machine-readable storage medium of claim 10, further comprising:
receiving, with the progress management system, notifications from the at least one third party service when a monitored resource is changed; and
process notifications received by the progress management system.

12. The non-transitory machine-readable storage medium of claim 11, further comprising:
attach data obtained from the notifications to an appropriate module within an interface of the progress management system for the user; and
update user records within a database of the progress management system.

13. The non-transitory machine-readable storage medium of claim 12, further comprising:
analyzing, with the progress management system, data from at least one resource of at least one third party service, wherein analyzing the data includes determining an external ID of the at least one resource being modified, determining a date and time when a modification to the at least one resource occurs, determining an external ID of a user who performed the modification, and applying a description of the modification to the resource.

14. The non-transitory machine-readable storage medium of claim 13, further comprising:
presenting this analyzed data in real time to a device of the user via a formatted integration user interface across all authorized resources of the user which have been monitored and analyzed.

15. The non-transitory machine-readable storage medium of claim 9, wherein the progress management system comprises a collaborative network-based graphical progress management platform.

16. The non-transitory machine-readable storage medium of claim 9, wherein the resources comprise at least two of a document, a hyperlink, a graphical object, a still image, an audio clip, and a video clip.

17. A collaborative network-based graphical progress management system comprising:
a communications interface through which to communicate with a plurality of remote processing devices, each associated with a separate one of a plurality of users;
a database to store records of the plurality of users; and
a processor coupled to the communications interface and the database and configured to execute operations to obtaining identification information to identify a user of an organization with respect to the collaborative network-based graphical progress management system, obtaining authentication information from at least one third party service of the user, accessing resources of the user for the at least one third party service;
attaching or linking these resources to one or more relevant modules within an interface of the collaborative network-based graphical progress management system for the user; and
initiating a data monitoring sequence for the at least third party service of the user.

18. The collaborative network-based graphical progress management system of claim 17, wherein the processor is further configured to execute operations to send an HTTP request to the at least one third party service that is being used by the user and to expose an HTTP endpoint such that the at least one third party service can send appropriate notifications to the progress management system when a monitored resource is changed.

19. The collaborative network-based graphical progress management system of claim 18, wherein the processor is further configured to execute operations to receive notifications from the at least one third party service when a monitored resource is changed and process notifications received by the progress management system.

20. The collaborative network-based graphical progress management system of claim 19, wherein the processor is further configured to execute operations in real time to attach data obtained from the notifications to an appropriate module within an interface of the progress management system for the user and to update user records within a database of the progress management system.

21. The collaborative network-based graphical progress management system of claim 20, wherein the processor is further configured to execute operations to analyze data from at least one resource of at least one third party service, wherein analyzing the data includes determining an external ID of the at least one resource being modified, determining a date and time when a modification to the at least one resource occurs, determining an external ID of a user who performed the modification, and applying a description of the modification to the resource.

22. The collaborative network-based graphical progress management system of claim 21, wherein the processor is further configured to execute operations to present this analyzed data in real time to a device of the user via a formatted integration user interface across all authorized resources of the user which have been monitored and analyzed.

23. The collaborative network-based graphical progress management system of claim 17, wherein the progress management system comprises a collaborative network-based graphical progress management platform.

24. The collaborative network-based graphical progress management system of claim 17, wherein the resources comprise at least two of a document, a hyperlink, a graphical object, a still image, an audio clip, and a video clip.
